(19) United States
(12) Patent Application Publication
(10) Pub. No.: US 2012/0227684 A1
(43) Pub. Date: Sep. 13, 2012

(54) HYDROGEN/OXYGEN GAS GENERATING APPARATUS AND INTERNAL COMBUSTION ENGINE SYSTEM HAVING THE SAME

(75) Inventors: Ra-Min Tain, New Taipei City (TW); Yao-Shun Chen, Hsinchu County (TW); Wei-Kuo Han, Hsinchu City (TW); Chun-Kai Liu, Taipei City (TW)

(73) Assignee: INDUSTRIAL TECHNOLOGY RESEARCH INSTITUTE, Hsinchu (TW)

(21) Appl. No.: 13/476,034

(22) Filed: May 21, 2012

Related U.S. Application Data
(63) Continuation-in-part of application No. 12/390,512, filed on Feb. 23, 2009.

(30) Foreign Application Priority Data
Dec. 25, 2008 (TW) 97150762

(51) Int. Cl. F02B 43/08; C25B 1/04; C25B 15/00; F01N 5/02; C25B 9/00

(52) U.S. Cl. 123/3; 60/320; 204/242; 204/274

(57) ABSTRACT

An internal combustion engine system including an electric power generating device, a container, a set of positive and negative electrodes and an internal combustion engine is provided. The container contains an electrolytic solution and has a gas outlet. The set of positive and negative electrodes are disposed within the electrolytic solution in the container, wherein the set of positive and negative electrodes are electrically connected to a first power output end and a second power output end of the electric power generating device, respectively. The internal combustion engine is connected to the gas outlet, wherein a gas product directed from the gas outlet is used as a fuel of the internal combustion engine. Further, the electric power generating device can be applied on a hydrogen/oxygen gas generating apparatus and integrated into the internal combustion engine system of a motor vehicle.

### CROSS-REFERENCE TO RELATED APPLICATION

This application is a continuation-in-part of and claims the priority benefit of U.S. application Ser. No. 12/390,512, filed on Feb. 23, 2009, which claims the priority benefit of Taiwan application serial no. 97150762, filed on Dec. 25, 2008. The entirety of each of the above-mentioned patent applications is hereby incorporated by reference herein and made a part of this specification.

### BACKGROUND OF THE DISCLOSURE

1. Field of the Disclosure

The disclosure relates to a hydrogen/oxygen gas generating apparatus and an internal combustion engine system.

2. Description of Related Art

Energy is an indispensable commodity in our daily lives. Moreover, energy can exist in various forms and is commonly present as heat energy, electric energy, and light energy. From a perspective of energy, some heat energy or electric energy can actually produce some beneficial results. However, some other energy become waste energy due to reasons regarding conversion efficiency and will be exhausted to the surrounding instead of being used continually. For example, an electronic apparatus using electric energy to perform some functional operations, such that the electronic apparatus also generates heat to produce waste heat. And another example is that an automobile using fuel material to perform its functional operations and also exhausts heat as a waste energy. The waste heat is usually dissipated to surrounding and not being utilized further. Moreover, if energy is present in forms of light energy or heat energy, but the energy demanded is electric energy, then an efficient converting apparatus or system will be required to perform the conversion.

The widely used traditional energy, such as petroleum, is gradually depleted. Therefore, the search for effective energy utilization and recycling is also one of the most important issues. Furthermore, other than the source-limited petroleum energy, the use of inexhaustible solar energy may also be considered. In addition, solar energy may also be converted into heat energy, electric energy, etc.

Therefore, how to convert waste heat into effective energy has always been one of the issues that need to be solved. Moreover, how to effectively convert heat energy into electric energy to perform all types of energy application is also a problem being considered by energy researchers.

In the TW patent publication 200809085, a heat-pipe electric power generating device has been disclosed. The heat-pipe electric power generating device disposes a magnet fixing rack on a rotary blade of a turbine to install the magnet, and disposes a pivoted portion on a base installed with the rotary blade of the turbine such that the pivoted portion aligns with a shaft of the rotary blade of the turbine. Also, an airflow passage is disposed on the base installed with the rotary blade of the turbine. The airflow passage is located behind the direction of which the rotary blade of the turbine spins along the vapor flow. Since the airflow passage is located behind the vapor flowing direction of the rotary blade of the turbine, the airflow passage only has the simple purpose of allowing the vapor to pass, and does not have the function of increasing the efficiency of spinning the turbine blade by vapor, thus can not increase the effect of power generation.

Moreover, the PCT publication WO2008/068491 A2 has disclosed an electric generator. Here, a heat-pipe used by the electric generator is assembled by clamping a non-metallic pipe between two halves of heat-pipes. The main purpose is to ensure the magnetic field will not be shielded by other metallic heat-pipes that are not made from copper. As the heat-pipe is assembled by clamping the non-metallic pipe between two halves of heat-pipes, slits may form at the seam of the two halves of heat-pipes and the non-metallic pipe, such that the interior of the heat-pipe can not reach the airtight state. Also, the electric generator embeds the coil in the non-metallic pipe, so the process of manufacturing the heat-pipe is more complicated and consequently increases the production cost.

### SUMMARY OF THE DISCLOSURE

The disclosure provides a hydrogen/oxygen gas generating apparatus having an electric power generating device. The apparatus directs the electric power generated by the electric power generating device into a water container to electrolyze water to produce hydrogen and oxygen.

The disclosure further provides an internal combustion engine system having the electric power generating device. The system generates electric power from the electric power generating device with waste heat from a motor vehicle, where the electric power is directly provided to the hydrogen/oxygen gas generating apparatus to produce hydrogen and oxygen. Afterward, the hydrogen and oxygen are mixed with air from the gas inlet of the engine of the motor vehicle and injected into the engine to ignite with oil gas to increase the working efficiency of the engine and decrease the volume of exhaust gas emission.

The disclosure provides a hydrogen/oxygen gas generating apparatus including an electric power generating device, a container and a set of positive and negative electrodes. The container contains an electrolytic solution and has a gas outlet. The set of positive and negative electrodes are disposed within the electrolytic solution in the container, wherein the set of positive and negative electrodes are electrically connected to a first power output end and a second power output end of the electric power generating device, respectively.

The disclosure further provides an internal combustion engine system including an electric power generating device, a container, a set of positive and negative electrodes and an internal combustion engine. The container contains an electrolytic solution and has a gas outlet. The set of positive and negative electrodes are disposed within the electrolytic solution in the container, wherein the set of positive and negative electrodes are electrically connected to a first power output end and a second power output end of the electric power generating device, respectively. The internal combustion engine is connected to the gas outlet, wherein a gas product directed from the gas outlet is used as a fuel of the internal combustion engine.

According to an embodiment of the disclosure, the electric power generating device includes a pipe body and a thermoelectric conversion module. The thermoelectric conversion module is disposed on the pipe body and has the first power output end and the second power output end. Moreover, a cold source of the hydrogen/oxygen gas generating apparatus is disposed on the thermoelectric conversion module of the electric power generating device. In addition, the first power output end and the second power output end of the thermoelectric conversion module is connected to the set of positive and negative electrodes of the hydrogen/oxygen gas generating apparatus, the efficiency of the thermoelectric conversion module is increased due to the increasing temperature difference between the cold source and the pipe body.

The hydrogen/oxygen gas generating apparatus having the electric power generating device directs the electric power generated by the electric power generating device into a water container to electrolyze water to produce hydrogen and oxygen.

The internal combustion engine system having the electric power generating device generates electric power from the electric power generating device with waste heat, where the electrical power is used to produce hydrogen and oxygen. Then, the hydrogen and oxygen produced are used as fuels and are directed to the internal combustion engine to increase the working efficiency of the internal combustion engine and decrease the volume of exhaust gas emission to achieve the efficacy of energy saving and carbon reduction.

To make the disclosure more comprehensible, several embodiments accompanied with figures are detailed as follows.

### BRIEF DESCRIPTION OF THE DRAWINGS

The accompanying drawings are included to provide a further understanding of the disclosure, and are incorporated in and constitute a part of this specification.

The drawings illustrate embodiments of the invention and, together with the description, serve to explain the principles of the disclosure.

FIG. 1 is a schematic diagram of an internal combustion engine system having an electric power generating device according to an exemplary embodiment of the disclosure.

FIG. 2 schematically shows the electric power generating device of FIG. 1.

FIG. 3 schematically shows the thermoelectric conversion module of FIG. 1.

FIG. 4 shows a schematic cross-sectional view of the electric power generating device taken along a line AA′ depicted in FIG. 2.

### DESCRIPTION OF EMBODIMENTS

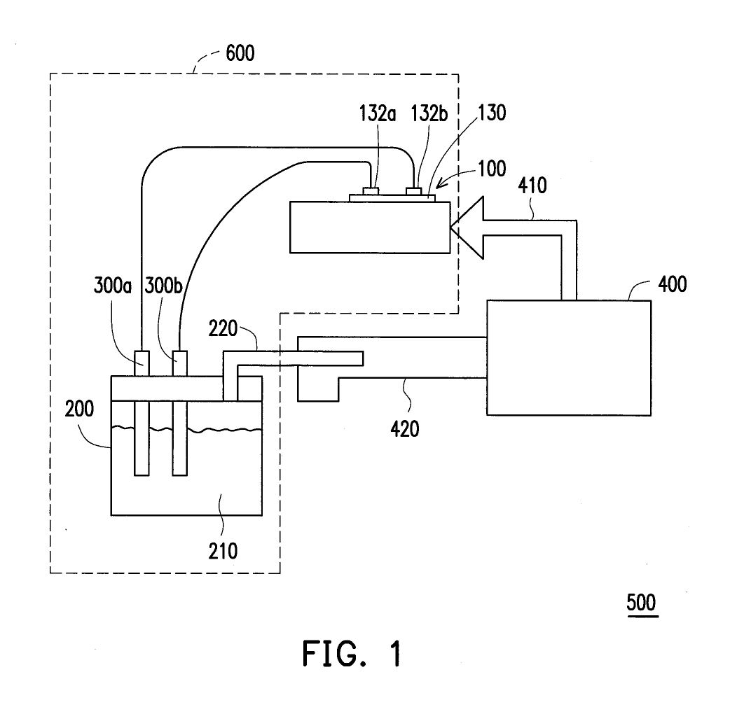

FIG. 1 is a schematic diagram of an internal combustion engine system having an electric power generating device according to an exemplary embodiment of the disclosure. Referring to FIG. 1, the internal combustion engine system 500 of an exemplary embodiment of the disclosure includes a hydrogen/oxygen gas generating apparatus 600 and an internal combustion engine 400. The hydrogen/oxygen gas generating apparatus 600 includes an electric power generating device 100, a container 200 and a set of positive and negative electrodes 300a and 300b.

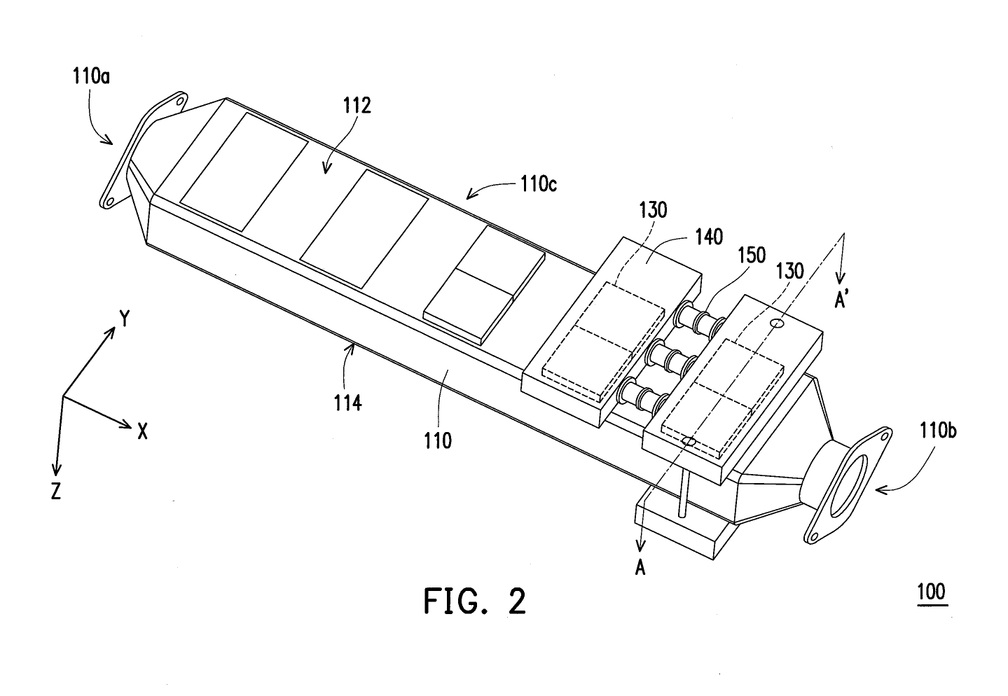

FIG. 2 schematically shows the electric power generating device of FIG. 1. Referring to FIG. 1 and FIG. 2, the electric power generating device 100 includes a pipe body 110 and a thermoelectric conversion module 130. In the embodiment, the pipe body 110 may be an exhaust pipe of an automobile, thus the temperature of the pipe body 110 may be in a range of 200 to 600° C., usually higher than the normal atmospheric temperature during operation. The electric power generating device 100 may be disposed in the exhaust system of the automobile, and the configuration and locations thereof can be designed according to the actual requirements. However, in other embodiments, the pipe body can be any other elements which would have a different temperature with the environment, and it is not limited thereto.

In order to convert the waste heat (e.g., heat of the exhaust gas in this embodiment) into electric power, the thermoelectric conversion module 130 is disposed on the pipe body 110, wherein the thermoelectric conversion module 130 has a first power output end 132a and a second power output end 132b. The first power output end 132a and the second power output end 132b are connected to the set of positive and negative electrodes 300a and 300b, respectively.

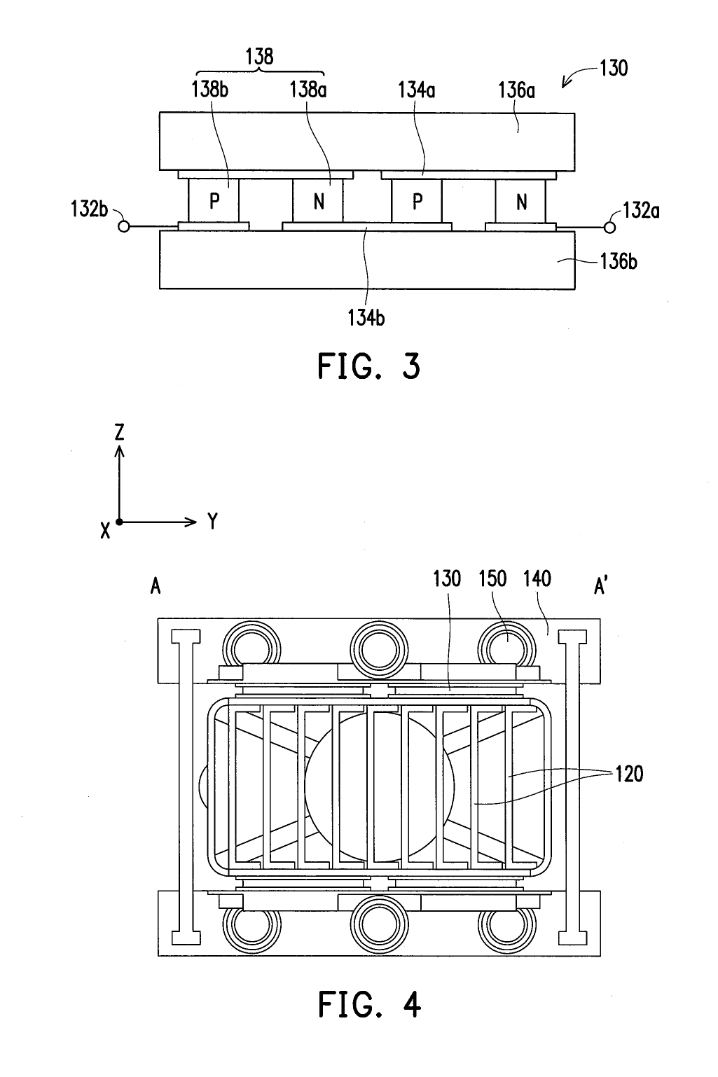

FIG. 3 schematically shows the thermoelectric conversion module of FIG. 1. Referring to FIG. 3, the thermoelectric conversion module 130 includes a first substrate 136a, a second substrate 136b, a plurality of thermoelectric couples 138, a plurality of first conductive layer 134a, and a plurality of second conductive layer 134b. Each of the thermoelectric couples 138 is respectively composed of an N-type thermoelectric element 138a and a P-type thermoelectric element 138b. The N-type thermoelectric elements 138a and the P-type thermoelectric elements 138b are, for example, arranged alternatively with each other, that is, two adjacent thermoelectric elements may have different configurations. The plurality of first conductive layer 134a is, for example, disposed between the first substrate 136a and the thermoelectric couples 138. Each of the first conductive layers 134a is respectively connected to the N-type thermoelectric element 138a and the P-type thermoelectric element 138b of each of the thermoelectric couples 138. The plurality of second conductive layer 134b is, for example, disposed between the second substrate 136b and the thermoelectric couples 138. Each of the second conductive layers 134b is respectively connected to the N-type thermoelectric element 138a and the P-type thermoelectric element 138b of the adjacent thermoelectric couples 138. The N-type thermoelectric element 138a and the P-type thermoelectric element 138b of each of the thermoelectric couples 138 are alternatively connected to each other in series by the first conductive layers 134a and the second conductive layers 134b. As shown in FIG. 3, the first power output end 132a is electrically connected to the N-type thermoelectric element 138a of the thermoelectric couples 138 arranged in the first position through the second conductive layers 134b, and the second power output end 132b is electrically connected to the P-type thermoelectric element 138b of the thermoelectric couples 138 arranged in the last position through the second conductive layers 134b. However, it is not limited thereto.

As shown in FIG. 1, the container 200 of the hydrogen/oxygen gas generating apparatus 600 contains an electrolytic solution 210 and a gas outlet 220. The electrolytic solution 210 is electrolyzed water, for example. The set of positive and negative electrodes 300a and 300b are disposed within the electrolytic solution 210 in the container 200. Herein the set of positive and negative electrodes 300a and 300b are electrically connected to the first power output end 132a and the second power output end 132b of the electric power generating device 100.

The internal combustion engine 400 is connected to the gas outlet 220 of the container 200. Herein the internal combustion engine 400 further includes a gas inlet 420 connected to the gas outlet 220 of the container 200. The gas product directed from the gas outlet 220 is used as a fuel for the internal combustion engine 400. For instance, the gas outlet 220 of the container 200 is connected with the gas inlet 420 of the internal combustion engine 400. Therefore, the gas product (hydrogen/oxygen) is mixed with air and directed into the internal combustion engine 400 so as to increase the ignition efficiency of the internal combustion engine 400 and reduce air pollution. After the operation of the internal combustion engine 400, the heat of exhaust gas generated by the internal combustion engine 400 can be transmitted to the electric power generating device 100. Herein the internal combustion engine 400 further includes an exhaust gas outlet 410 to exhaust a hot gas generated by the internal combustion engine 400 to the electric power generating device 100. And the heat generated by the internal combustion engine 400 is transmitted to the electric power generating device 100 via the exhaust gas outlet 410.

FIG. 4 shows a schematic cross-sectional view of the electric power generating device taken along a line AA′ depicted in FIG. 2. Herein the electric power generating device 100 is described with figures. As shown in FIG. 2 and FIG. 4, the electric power generating device 100 further includes a cold source 140 disposed on the thermoelectric conversion module 130, so that there can be a large temperature difference present between the pipe body 110 and the cold source 140 and the efficiency of the electric power generating device 100 can further be improved. It has to be noted that the cold source 140 may include a plurality of cooling pipes 150 for accommodating cooling elements therein, for example. In this embodiment, the cold terminal surface of the thermal conversion module 130 may be closely coupled to the cold source 140, while the hot terminal surface of the thermal conversion module 130 may be closely coupled to the pipe body 110. Such configuration may enhance the efficiency of the thermal conversion module 130 due to the increased temperature difference between the cold terminal surface and the hot terminal surface.

More specifically, the pipe body 110 includes a gas inlet 110a, a gas outlet 110b and a heat exchange section 110c, wherein the heat exchange section 110c is located between the gas inlet 110a and the gas outlet 110b as shown in FIG. 2. In the embodiment, the cross-section of the pipe body 110 may be a rectangular shape, but the present disclosure is not limited thereto. For convenience of illustration, the heat exchange section 110c is defined to have a top surface 112 and a bottom surface 114 opposite to the top surface 112.

Referring to FIG. 1 to FIG. 4, the electric power generating device 100 further has a plurality of thermal conductive fins 120 disposed in the heat exchange section 110c of the pipe body 110. In the embodiment, the thermal conductive fins 120 are contact with the opposite side of the top surface 112 and the opposite side of the bottom surface 114. In order to enhance the heat conducting performance, the thermal conductive fins 120 can be arranged in parallel to each other in the pipe body 110, but the present disclosure is not limited thereto. Moreover, each of the thermal conductive fins 120 has an extending direction, and the extending direction is parallel to a longitudinal direction (i.e., Z direction as shown in FIG. 2 and FIG. 4) of the pipe body 110. However the structures and configuration of the thermal conductive fins are not limited in the disclosure.

Next, the operating principle of the internal combustion engine system 50 of the embodiment is illustrated.

Firstly, a fuel tank (not shown) supplies fuels to the internal combustion engine 400, so that the internal combustion engine 400 can operate to generate kinetic energy, heat energy and exhaust gas. Herein, the exhaust gas is transmitted to the gas inlet 110a of the pipe body 110 of the electric power generating device 100. The heat of exhaust gas may effectively conducted to the top surface 112 and the bottom surface 114 (the entire surface of the pipe body 110) of the pipe body 110, since the thermal conductive fins 120 are arranged in parallel and contact with the top surface 112 and the bottom surface 114. The electric power generating device 100 operates to generate electrical energy. The electrical energy comes out from the first power output end 132a and the second power output end 132b of the thermoelectric conversion module 130. Then, the electrical energy is provided to the set of positive and negative electrodes 300a and 300b, and electrolyzes the electrolytic solution 210 in the container 200 to generate the gas product (hydrogen, oxygen). The gas product (hydrogen, oxygen) is directed from the gas outlet 220 and mixed with air to be directed into the internal combustion engine 400 to increase the ignition efficiency of the internal combustion engine 400 and reduce air pollution. Accordingly, such circulation is performed in the internal combustion engine system 500 of the embodiment.

The hydrogen/oxygen gas generating apparatus 600 having the electric power generating device 100 of the embodiment of the disclosure directs the electric power generated by the electric power generating device 100 into the container 200 to electrolyze water to generate hydrogen and oxygen.

In the internal combustion engine system 500 having the electric power generating device 100 of the embodiment of the disclosure, waste heat is used by the electric power generating device 100 to generate electric power, which is directly supplied to the hydrogen/oxygen gas generating apparatus to produce hydrogen and oxygen. Next, the produced hydrogen and oxygen are mixed with air from the gas inlet 420 and injected to the internal combustion engine 400 to ignite with oil gas, such that the working efficiency of the internal combustion engine is increased and the volume of exhaust gas emission is decreased. In other words, the internal combustion engine system 500 of the disclosure can convert waste heat into electric energy, which is used to produce hydrogen and oxygen. The generated hydrogen and oxygen can be used as fuels and are directed into the internal combustion engine to thereby achieve the efficacy of energy saving and carbon reduction.

In light of the foregoing, the electric power generating device of the embodiment of the disclosure is integrated with the hydro/oxygen gas generating apparatus and the internal combustion engine in the internal combustion engine system. The electric power generating device of the disclosure can also be disposed on any other apparatus that generates heat energy. Hence, an apparatus with heat recycling function can be assembled. For example, the thermoelectric conversion module can be integrated with a heat-pipe, or the thermoelectric conversion module can be disposed in a computer system. Therefore, besides from heat dissipation, the heat energy can also be recycled. Furthermore, in another example, an air conditioner is also an apparatus that generates a lot of waste heat. Thus, the disclosure can be integrated into the air conditioner to recycle the waste heat. Similar applications as such will not be listed herein.

The novel electric power generating device provided in the disclosure simply utilizes the exhaust pipe (or any other pipes which generates waste heat) to recycle heat energy or actively convert heat energy into electric energy.

On the contrary, the electric power generating device and the application thereof in the disclosure also provide another option for energy processing in an overall consideration.

Although the present disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A hydrogen/oxygen gas generating apparatus, comprising:
an electric power generating device;
a container, containing an electrolytic solution and having a gas outlet; and
a set of positive and negative electrodes, disposed within the electrolytic solution in the container, wherein the set of positive and negative electrodes are electrically connected to a first power output end and a second power output end of the electric power generating device, respectively.

2. The hydrogen/oxygen gas generating apparatus as claimed in claim 1, wherein the electric power generating device comprises:
a pipe body; and
a thermoelectric conversion module disposed on the pipe body and having the first power output end and the second power output end.

3. The hydrogen/oxygen gas generating apparatus as claimed in claim 2, wherein the electric power generating device further comprises a cold source disposed on the thermoelectric conversion module.

4. The hydrogen/oxygen gas generating apparatus as claimed in claim 2, wherein the thermoelectric conversion module comprises a plurality of thermoelectric couples.

5. The hydrogen/oxygen gas generating apparatus as claimed in claim 2, wherein the pipe body comprises a gas inlet, a gas outlet and a heat exchange section, wherein the heat exchange section is located between the gas inlet and the gas outlet, and the heat exchange section has a top surface and a bottom surface opposite to the top surface.

6. The hydrogen/oxygen gas generating apparatus as claimed in claim 5, further comprising a plurality of thermal conductive fins disposed in the heat exchange section and contacted with the top surface and the bottom surface.

7. The hydrogen/oxygen gas generating apparatus as claimed in claim 1, wherein the electrolytic solution is electrolyzed water.

8. The hydrogen/oxygen gas generating apparatus as claimed in claim 3, wherein the cold source comprises a plurality of cooling pipes for accommodating cooling elements therein.

9. The hydrogen/oxygen gas generating apparatus as claimed in claim 1, wherein the pipe body comprises an exhaust pipe.

10. An internal combustion engine system, comprising:
an electric power generating device;
a container, containing an electrolytic solution and having a gas outlet;
a set of positive and negative electrodes, disposed within the electrolytic solution in the container, wherein the set of positive and negative electrodes are electrically connected to a first power output end and a second power output end of the electric power generating device, respectively; and
an internal combustion engine, connected to the gas outlet, wherein a gas product directed from the gas outlet is used as a fuel of the internal combustion engine.

11. The internal combustion engine system as claimed in claim 10, wherein the electric power generating device, comprises:
a pipe body; and
a thermoelectric conversion module disposed on pipe body and having the first power output end and the second power output end.

12. The internal combustion engine system as claimed in claim 11, wherein the electric power generating device further comprises a cold source disposed on the thermoelectric conversion module.

13. The internal combustion engine system as claimed in claim 11, wherein the thermoelectric conversion module comprises a plurality of thermoelectric couples.

14. The internal combustion engine system as claimed in claim 11, wherein the pipe body comprises a gas inlet, a gas outlet and a heat exchange section, wherein the heat exchange section is located between the gas inlet and the gas outlet, and the heat exchange section has a top surface and a bottom surface opposite to the top surface.

15. The internal combustion engine system as claimed in claim 14, further comprising a plurality of thermal conductive fins disposed in the heat exchange section and contacted with the top surface and the bottom surface.

16. The internal combustion engine system as claimed in claim 10, wherein the internal combustion engine further comprises an exhaust gas outlet, connected to the electric power generating device to exhaust a hot gas generated by the internal combustion engine to the gas inlet of the pipe body.

17. The internal combustion engine system as claimed in claim 10, wherein the electrolytic solution is electrolyzed water.

18. The internal combustion engine system as claimed in claim 10, wherein the internal combustion engine has a gas inlet connected to the gas outlet.

19. The internal combustion engine system as claimed in claim 12, wherein the cold source comprises a plurality of cooling pipes for accommodating cooling elements therein.

20. The internal combustion engine system as claimed in claim 11, wherein the pipe body comprises an exhaust pipe.
